(19) United States
(12) Patent Application Publication
(10) Pub. No.: US 2009/0104494 A1
(43) Pub. Date: Apr. 23, 2009

(54) Creep-Resistant Ferritic Steel

(76) Inventors: Willem J. Quadakkers, Wijnandsrade (NL); Leszek Niewolak, Juelich (DE); Phillip James Ennis, Birmingham (GB)

Correspondence Address: JORDAN AND HAMBURG LLP, 122 EAST 42ND STREET, SUITE 4000, NEW YORK, NY, 10168, US

(21) Appl. No.: 12/223,949

(22) PCT Filed: Jan. 31, 2007
(86) PCT No.: PCT/DE2007/000166

§ 371 Date: Oct. 30, 2008

(30) Foreign Application Priority Data
Feb. 18, 2006 (DE) 10 2006 007 598.6

(51) Int. Cl. H01M 4/02; C22C 38/18

(52) U.S. Cl. 429/27; 148/326

(57) ABSTRACT

Provided is a ferritic steel that is particularly creep-resistant at temperatures from 600 to 1000° C. The ferritic steel comprising precipitations of an intermetallic phase of the Fe₂(M, Si)-type or Fe₇(M, Si)ₛ-type, wherein M is a metal, particularly niobium, molybdenum, tungsten and/or tantalum. The precipitations being formed at high temperatures. The alloy can additionally comprise chromium. The steel can be used, among other things, for the bipolar plate in a stack of high-temperature fuel cells.

The invention relates to a creep-resistant ferritic steel for components subject to high temperatures, and particularly for use in high-temperature fuel cells.

### STATE OF THE ART

A high-temperature fuel cell (solid oxide fuel cell, SOFC) converts the chemical energy of a fuel, such as hydrogen, methane, or carbon monoxide, directly into electric energy by using an oxidant, such as oxygen or air. The fuel is separated from the oxidant by a solid electrolyte, such as yttrium-stabilized zirconium oxide. At a cell operating temperature of between 600 and 1000° C., the solid electrolyte conducts oxygen ions from the oxygen side (cathode region) to the fuel side (anode region), where they react with the fuel. In the process, electrons are released, which can supply an external load.

The solid electrolyte is coated with porous, catalytically active electrode materials. In general, the anode on the fuel side is made of a cermet of metallic nickel and yttrium-stabilized zirconium oxide. The cathode on the oxygen side is typically made of perovskite, based on lanthanum.

As an individual fuel cell only emits a low voltage in the range of 1 volt, and a plurality of fuel cells must be interconnected for most technical applications. Typically, for this purpose a plurality of cells are layered to form a so-called stack. To this end, a bipolar plate is required between every two cells, which is also referred to as the interconnector. The bipolar plate conducts the current from one cell to the neighboring cell and at the same time divides the cathode region of one cell from the anode region of the other cell in a gastight manner. In most SOFC flat cell designs under discussion today, the bipolar plate also assumes the function of distributing the gas in the cells and provides the cells with mechanical stability (EP 0338 823 A1). For this reason, in contrast to the electrolyte and the electrodes, which are about 100 μm thick, the bipolar plate is typically several millimeters thick. In more recent SOFC designs, particularly for mobile applications in vehicles or airplanes, however, the bipolar plates are already configured considerably thinner (0.3 to 1 mm) for weight saving reasons.

The demands placed on a bipolar plate are diverse. It must exhibit high oxidation resistance at high temperatures, while fuel is applied on one side and oxygen on the other side. In addition, it is mechanically firmly connected to the remaining components of the cell, some of which are made of ceramics. In order to ensure that temperature fluctuations do not result in any mechanical stress, which could destroy the remaining components, the coefficient of thermal expansion (approx. 10 to 12*10⁻⁶ K⁻¹) of the bipolar plate must be suited to the remaining components. The exact value of the coefficient of expansion requires depends on the respective cell design. Anode substrate supported cells typically require slightly higher coefficients of expansion than cell designs that are based on an electrolyte film design.

Ferritic chromium steels can generally satisfy this requirement profile. These materials form an oxide layer based on Cr₂O₃ on the surface, the layer protecting the inside of the material from corrosion. However, these layers are typically unstable at the high operating temperatures of high-temperature fuel cells. They flake and as a result the fragments can clog the gas ducts of the bipolar plate and impair gas flow. Furthermore, over time they grow thicker due to further corrosion, which increasingly reduces electrical conductivity and therefore the power output of the fuel cell stack. In addition, if a high oxygen supply is present, as is the case in the cathode region, volatile chromium oxides or chromium hydroxides are formed, which act as a catalyst poison on the cathode, or on the interface between the cathode and the electrolyte, and thereby further permanently reduce the cell power.

For the stabilization of the chromium oxide layers, DE 44 10 711 C1 discloses a bipolar plate made of a chromium oxide-forming alloy, the plate being provided with a protective coating made of aluminum in the region of the gas-conducting surfaces. At the operating temperature, the aluminum layer on the surface thereof forms an Al₂O₃ layer, which protects the chromium oxide layer from corrosion. The disadvantageous decrease in electrical conductivity due to the chromium oxide layers in the region of the contact surfaces between the electrodes and bipolar plate, however, is something that still must be accepted.

Furthermore, a component for conducting current for high-temperature fuel cells is known from EP 04 10 166 A1. This component comprises a non-oxidizable metallic casing made of gold, palladium, or platinum, which has high electrical conductivity and does not lose any material due to evaporation. However, such a component is very expensive to produce, and the stability thereof during long-term operation is not assured.

DE 44 22 624 A1 describes a method for protecting chromium-containing bodies, wherein a protective coating made of oxidic chromate is applied. A disadvantage of these coating methods, however, is that they make the bipolar plates considerably more expensive. In addition, the layers have no self-healing capability during operation if they are mechanically damaged.

DE 100 25 108 A1 discloses new compositions for ferritic interconnector materials. Through a special combination of alloying elements, it was possible to form oxide layers on steel surfaces at conventional operating temperatures, the layers having a low growth rate, excellent adhesion to the metal substrate, high electrical conductivity and low chromium evaporation. In order to achieve this combination of advantageous properties, for example, the maximum concentrations of the alloying elements of aluminum and silicon were limited to very low values. Since these elements are frequently added as deoxidants during conventional steel production, the advantageous steel properties can often only be achieved by using novel, complex and therefore expensive production methods.

Particularly in the case of stacking designs that provide for only low interconnector thicknesses (such as 0.3-1 mm), high operating temperatures (above about 800° C.) and frequent temperature changes (such as several hundred, or even several thousand, temperature changes during the operating time of the cell), one particular property of ferritic steels disadvantageously stands out. At high temperatures, these steels have only low creep resistance. Thus, when subject to mechanical stress caused, for example, by oxidation, there is a tendency to permanent plastic deformation. As a result, the gastight seal between two fuel cells achieved by the bipolar plate can break open and the entire fuel cell stack can fail.

Typically, in order to increase creep resistance, transition metals, refractory metals, or light metals are added by way of alloying. The disadvantage is that transition metals frequently bring about austenitizing of the material, which increases the coefficient of expansion and worsens the oxidation resistance. In addition, refractory metals often reduce the ductility of the material. Light metals typically worsen the protective properties and electrical conductivity of the Cr-based oxidic cover layers, even if they are only present in very low concentrations of 0.1 to 0.4 weight percent. Steels made creep-resistant in this way are therefore not suited as materials for producing the interconnector of a high-temperature fuel cell.

### OBJECT AND SOLUTION

The object of the invention is therefore to provide a ferritic steel, which is suited as a production material for the interconnector of a high-temperature fuel cell, and which exhibits better creep resistance at temperatures above 600° C. than the steels used according to the state of the art.

A further object of the invention is to provide a bipolar plate, which is lastingly gastight, even with frequent temperature changes, and which is made of the ferritic steel mentioned above, and a fuel cell stack with an improved service life at high temperatures and frequent temperature changes.

These objects are achieved according to the invention by a steel according to the main claim and by the use of the steel in a bipolar plate and in a fuel cell stack according to the independent claims. Further advantageous embodiments will be apparent from the dependent claims referring to these claims.

### SUBJECT MATTER OF THE INVENTION

The ferritic steel comprises precipitations of an intermetallic phase of the Fe₂(M, Si) or Fe₇(M, Si)₆ type having at least one metal alloying element M. This intermetallic phase can be formed in advance during production of the steel. However, it can also be formed following subsequent heat treatment, or during subsequent use of the steel at temperatures between 600 and 1000° C.

In principle, any metal that, together with iron, forms an intermetallic phase of the Fe₂M or Fe₇M₆ type, and particularly niobium, molybdenum, tungsten or tantalum, is suited as the alloying element M. It is also possible to use a combination of a plurality of metals M.

It was found that the addition of such metals by alloying per se according to the state of the art renders the steel unsuitable for use in a high-temperature fuel cell as a result of two physical mechanisms of action that are independent from each other. Firstly, precipitations of the Fe₂M or Fe₇M₆ type have an extremely inadequate oxidation resistance. As a result, at high temperatures quickly growing oxides form locally. Secondly, the element M present in the alloying matrix is incorporated in the Cr oxide layer and thereby considerably increases the growth rate.

According to the invention, the metal M is partially substituted by silicon in the intermetallic phase. The intermetallic phase then has a general chemical formula of the Fe₂(M, Si) type or Fe₇(M, Si)₆ type. Surprisingly, it was found that, as a result, the oxidation resistance of the intermetallic phases mentioned above is significantly increased at high temperatures, particularly in contact with operating atmospheres of high-temperature fuel cells. At the same time, disadvantageous integration of the metal M into the Cr oxide layer is suppressed.

It was also recognized that, in the substitution of the metal M, silicon usually does not bring about the disadvantageous effect known from the state of the art for light-metal alloying elements since the silicon is dissolved in the intermetallic phase. The disadvantageous effect according to the state of the art was caused by the internal oxidation of the silicon at high temperatures.

Internal oxidation shall be understood as the formation of oxide precipitations within the alloy, beneath the oxidic, external cover layer on the alloy surface.

As a consequence of the internal oxidation process, metal inclusions developed in the chromium oxide cover layer due to the volume increase, and partially continuous Si oxide layers were formed beneath the chromium oxide. These disadvantageous effects of the silicon are suppressed in the case of substitution of the metal M by silicon according to the invention, as long as, at a maximum, only an amount of silicon is added that can still completely dissolve in the intermetallic phase. The maximum effective ratio for the silicon and metal M depends both on the selection of the metal M and the composition of the base material. For the specific application, those skilled in the art will be able to determine this ratio without undue experimentation.

Due to the substitution according to the invention of the metal M by silicon, for applications in high-temperature fuel cells, with a view to higher creep resistance, it is possible to introduce more precipitations of the Fe₂(M, Si) or Fe₇(M, Si)₆ intermetallic phase in the ferritic alloying matrix than was possible according to the state of the art with Fe₂M or Fe₇M₆. These precipitations significantly increase the creep resistance compared to an alloy that has no precipitations of the Fe₂(M, Si) or Fe₇(M, Si)₆ type.

As a typical example, ferritic steel having 22 wt % chromium and 0.4 wt % manganese shall be mentioned here. At 700° C., this steel has a consistent creep of 1.5% under a load of 10 MPa after 1000 hours. By adding elements M, such as niobium and/or tungsten, in an amount of only 1 wt % in combination with a silicon addition of 0.3 wt %, the permanent creep of the steel at the same chromium and manganese contents decreases to 0.06%, which is to say by about a factor of 25.

According to the state of the art, the maximum permitted content of precipitations of the Fe₂M type or Fe₇M₆ type was very limited. The inadequate oxidation resistance of the precipitations of the Fe₂M or Fe₇M₆ type meant that, when using the steel in the high-temperature fuel cell, very rapidly growing oxide layers formed. This was disadvantageous particularly for chromium oxide-forming steels because, locally, the formation of the protective Cr-based oxidic cover layers was impaired, or the growth rate was accelerated. As a result, the material became less corrosion-resistant overall. With regard to the content of Fe₂M and/or Fe₇M₆ in the alloy, it was thus always necessary to find a compromise between increasing the creep resistance and reducing the oxidation resistance. The partial substitution, according to the invention, of the metal M by silicon removes the restriction in the maximum possible creep resistance resulting from this compromise.

Advantageously, the steel contains the metal M and silicon in such concentrations that an intermetallic phase of the Fe₂(M, Si) or Fe₇(M, Si)₆ type is able to form at temperatures between 700° C. and 900° C. This temperature range corresponds to the target operating temperature of modern high-temperature fuel cells and is therefore technologically particularly relevant. The amount of metal M that is required will be apparent from known phase diagrams. For example, in order to form a Fe₂Nb phase in the temperature range of between 700 and 900° C., the alloy requires a niobium content of at least approximately 0.2 wt %. In order to form the Fe₂W phase at 800° C., the alloy requires a tungsten content of at least approximately 3 wt %. If the metal M and silicon are present in these advantageous concentrations, the intermetallic phase can be formed at the time of the first use of the steel in a high-temperature fuel cell. However, alternatively, it can also still be formed directly during the production of the steel.

The alloy should have precipitations of Fe₂(M, Si) and/or Fe₇(M, Si)₆ in the amount of between 1 and 8 percent by volume, and preferably between 2.5 and 5 percent by volume. At percentages below this range, the increase in creep resistance is technically insignificant. Percentages above this range, however, regularly result in undesirable embrittlement of the alloy.

The sum of the precipitations of the Fe₂(M, Si) phase and/or Fe₇(M, Si)₆ should range between 2 and 15 at % of silicon. At a silicon content of less than 2 at % in the Fe₂(M, Si) and/or Fe₇(M, Si)₆ phase, the oxidation resistance of the intermetallic phase is inadequate. A silicon content above 15 at % exceeds the solubility limit of the silicon in the intermetallic phase, so that the known disadvantages of silicon as an alloying element gradually begin to recur as the silicon oxidizes internally. A silicon content in the advantageous range between 2 and 15 at % in the intermetallic phase is achieved, for example when using niobium as the only metal M, with a mass ratio of silicon to niobium of between 0.08 and 1, and more preferably between 0.1 and 0.4. In this way, for example, in a ferritic steel with 22 wt % chromium and an addition of niobium and silicon of 0.6 or 0.25 wt % during use at 800° C., precipitations of the Fe₂(Nb, Si) type form, having a silicon percentage of about 7 at %. The sum of all precipitations results in a percentage of about 1 vol % in the steel.

In combination with the above-described measures for increasing the creep resistance, the advantageous measures described below can be used to achieve optimal suitability as a production material for the interconnector of a high-temperature fuel cell, without compromising the higher creep resistance achieved according to the invention.

Advantageously, the sum of the concentrations of nickel and cobalt in the alloy is greater than 0 but less than 4 wt %, and preferably less than 1 wt %. This prevents alloy transitioning into an austenitic structure at high temperatures, as will, for example, occur predominantly in a high-temperature fuel cell.

Advantageously, the concentrations of carbon, nitrogen, sulfur, boron and phosphorus in the alloy each are greater than 0 but less than 0.1 wt %, and preferably less than 0.02 wt %. These elements are accompanying elements and contaminations typically present in ferritic steels. In general, higher additions of these alloying elements bring about an embrittlement of the material, particularly at the alloy grain boundaries.

Advantageously, the alloy contains between 12 and 28 wt %, and preferably between 17 and 25 wt %, of chromium. The steel then becomes a chromium oxide forming agent. At high temperatures, particularly in a high-temperature fuel cell, it forms a protective oxidic cover layer based on chromium. As a result of the cover layer, the steel is protected from corrosion, particularly in the oxidic atmosphere of a fuel cell. The chromium content necessary for forming the cover layer depends on the operating temperature at which the steel is used, and can be determined by the person skilled in the art without undue experimentation. In general, higher operating temperatures require higher chromium contents.

The cover layer is particularly advantageous in high-temperature fuel cells as it forms spontaneously at normal operating temperatures ranging between 600 and 1000° C. As a result, it is automatically self-healing if defects should occur. This is particularly advantageous if the cell is exposed to frequent temperature changes due to startup and shutdown. Under such conditions, the service life of the fuel cell is thus increased.

The chromium content can also be used to adjust the coefficient of thermal expansion of the steel. This is particularly advantageous if the steel is used to produce an interconnector plate (bipolar plate) for a fuel cell stack. In such a stack, one side of the plate is firmly mechanically connected to the cathode material of a cell, and the other side of the plate is connected to the anode material of the other cell. If the coefficient of expansion of the bipolar plate differs too greatly from that of the cathode or anode material, high mechanical stresses occur. These may cause a tearing of the cathode, anode, or the solid electrolyte provided between the cathode and anode of a cell, resulting in the failure of the cell. Typically, between 800° C. and room temperature, the coefficient of thermal expansion of a ferritic steel, which comprises chromium as the only substantial alloying element is about 16*10⁻⁶ K⁻¹ at a chromium content of 9% and about 13*10⁻⁶ K⁻¹ at a chromium content of 22%.

Advantageously, the alloy comprises at least one element having oxygen affinity, such as yttrium, lanthanum, zirconium, cerium or hafnium, in the case of the chromium oxide-forming agent. The total concentration of elements having oxygen affinity in the alloy can range between 0.01 and 1 wt %, and preferably between 0.05 and 0.3 wt %. The addition of an element having oxygen affinity, or a combination of a plurality of elements having oxygen affinity, effects a reduction in the growth rate and an improvement in the adhesion of the oxidic chromium-based cover layer. This is advantageous, since high growth rates result in a rapid reduction of the wall thickness of thin components. In addition, as a result of high growth rates, the critical thickness resulting in flaking of the oxide layers is achieved after only a short time, thereby unacceptably inhibiting the gas flow in the narrow gas ducts of a high-temperature fuel cell.

The alloy may also contain the element having oxygen affinity in the form of an oxide dispersion, such as Y₂O₃, La₂O₃, or ZrO₂. The concentration of the respective oxide dispersion in the alloy should then range between 0.1 and 2 wt %, and preferably between 0.4 and 1 wt %. The advantage of the oxide dispersion compared to the introduction in a metal form is that the high-temperature resistance is increased. Steels having oxide dispersions can be produced, for example, by means of powder metallurgy.

The alloy advantageously comprises an element E, which forms a spinel phase with Cr₂O₃ of the ECr₂O₄ type, on the surface of the steel, at temperatures above 500° C. Examples of such elements are manganese, nickel, cobalt and copper, with manganese having been proven to be particularly suited. The concentration of the element E in the alloy should range between 0.05 to 2 wt %, and preferably 0.2 to 1 wt %. As a result of the spinel formation, the workpiece causes the evaporation of fewer volatile chromium compounds than would be the case with a workpiece that forms a pure chromium oxide cover layer. Such volatile chromium compounds are particularly undesirable on the inside of a high-temperature fuel cell, since they are catalyst poisons and permanently reduce cell performance. Due to the spinel formation on the chromium oxide layer, for example, the evaporation of volatile chromium compounds at 800° C. in moist air is reduced by a factor of 5 to 20.

In a further advantageous embodiment of the invention, the alloy has less than 0.5 wt %, preferably less than 0.15 wt %, of aluminum. In this way, aluminum oxide inclusions are prevented from forming in the steel in the zone beneath the chromium-based oxide cover layer at high temperatures, particularly at the alloy grain boundaries. These inclusions must be avoided as they disadvantageously impact the mechanical properties of the steel and furthermore bring about a formation of metal inclusions in the chromium oxide layer due to volume increase. These metal inclusions in turn impair the protective properties of the chromium oxide layer.

In addition, the low aluminum content notably prevents the formation of aluminum-rich, electrically insulating oxide layers on the surface of the steel. Such oxide layers have a particularly disadvantageous effect if the steel is used to produce the bipolar plate for a fuel cell stack. The current produced by the fuel cell stack must cross all bipolar plates in the stack. Consequently, insulating layers on these plates increase the internal resistance of the stack and considerably reduce the power output.

Advantageously, the alloy has a low addition of titanium of less than 0.2 wt %, preferably less than 0.1 wt %. At such low concentrations, extremely finely divided particles made of titanium-oxide form beneath the chromium oxide cover layer at high temperatures. This brings about a strengthening of the material inside this zone, whereby buckling of the surface due to oxidation-induced stress is suppressed. At higher titanium concentrations, similar disadvantageous effects occur as with excessive aluminum contents.

Within the scope of the invention it was found that a bipolar plate that is made of the steel according to the invention has particular advantages for use in a fuel cell stack, and particularly for use in a bipolar plate for a fuel cell stack. The steel according to the invention can be tailored so that the plate is oxidation-resistant at the typical operating temperatures of high-temperature fuel cells, exhibits good electrical conductivity (including the oxide layers forming on the surfaces), and has a low evaporation rate for volatile chromium compounds (chromium oxide and/or chromium oxyhydroxide). In addition, the steel has a low coefficient of thermal expansion (similar to the ceramic components of a high-temperature fuel cell). It can be hot and cold formed and can also be machined using conventional methods. It was recognized that, based on these advantageous characteristics, the power output and service life of a fuel cell stack can be considerably increased by providing it with bipolar plates made of the steel according to the invention.

The steel described here can also be used for other technical fields, in which high oxidation/corrosion resistance and high creep resistance, combined with high electrical conductivity for the chromium oxide layer formed during operation, are required, possibly with the additional provision of low chromium evaporation. For example, it can be used for electrodes or for electrode holders in liquid metals and melts. Furthermore, due to the special combination of properties, it can be used as a production material for electric filters for flue gases and as a heat conductor material or current collector for ceramic heat conductors, for example based on molybdenum silicon or silicon carbide. The material can also be used in oxygen detectors, such as Lambda probes. Steam-conducting pipes in power plants constitute a further field of application.

To this end, the novel material can replace presently used ferritic 9-12% Cr steels, particularly if the operating temperatures are raised from the presently typical range of 500 to 550° C. to 600 to 700° C., with a view to better efficiency.

### SPECIFIC DESCRIPTION

The object of the invention will be explained in more detail below with reference to the embodiments and figures, without thereby limiting the object of the invention. Shown are:

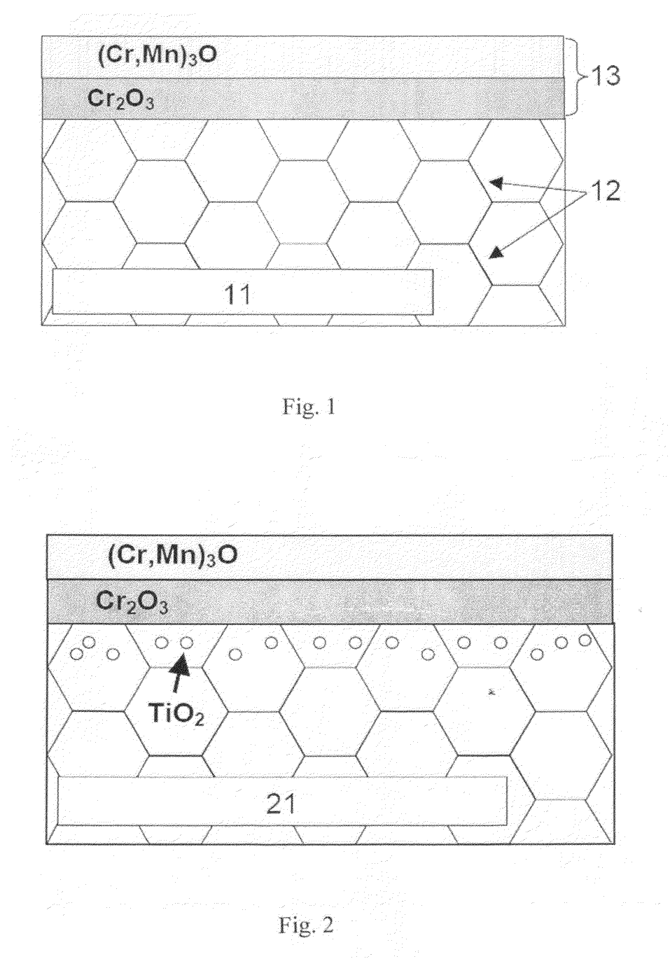

FIG. 1: Oxide layer 13 on an alloy 11 made of iron, chromium, manganese and lanthanum.

FIG. 2: Oxide layer 13 on an alloy 21 made of iron, chromium, manganese and lanthanum with the addition of titanium.

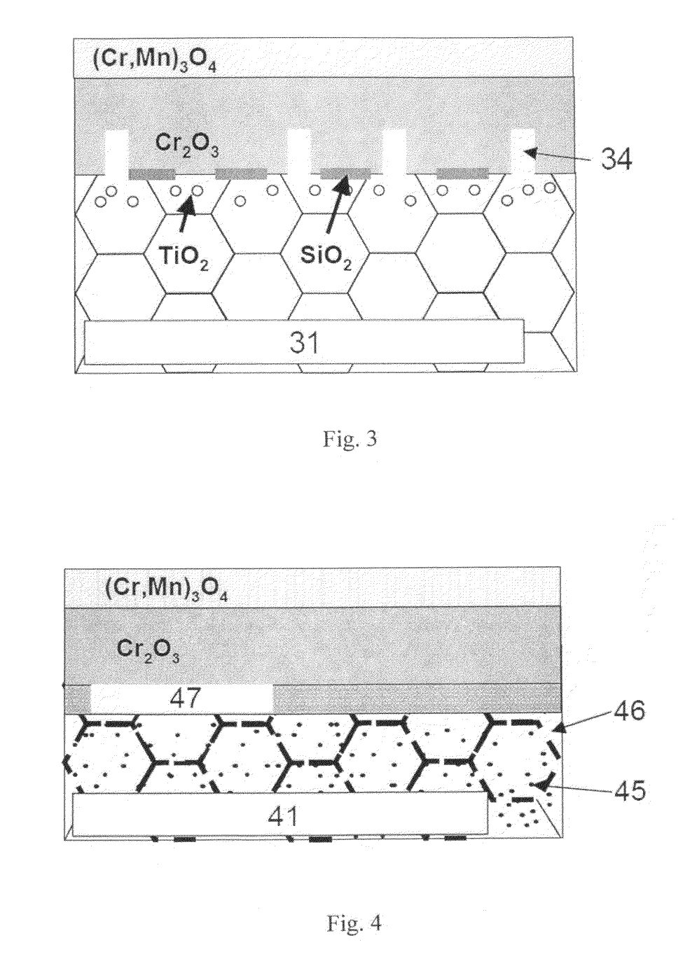

FIG. 3: Oxide layer 13 on an alloy 31 made of iron, chromium, manganese and lanthanum with the addition of titanium and substitution by silicon.

FIG. 4: Oxide layer on an alloy 41 made of iron, chromium, manganese, lanthanum, niobium and tungsten, comprising a niobium-rich oxide layer 47 disposed between the oxide layer 13 and alloy 41.

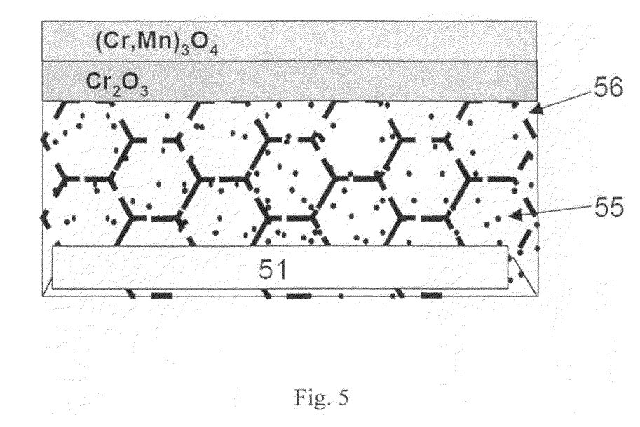

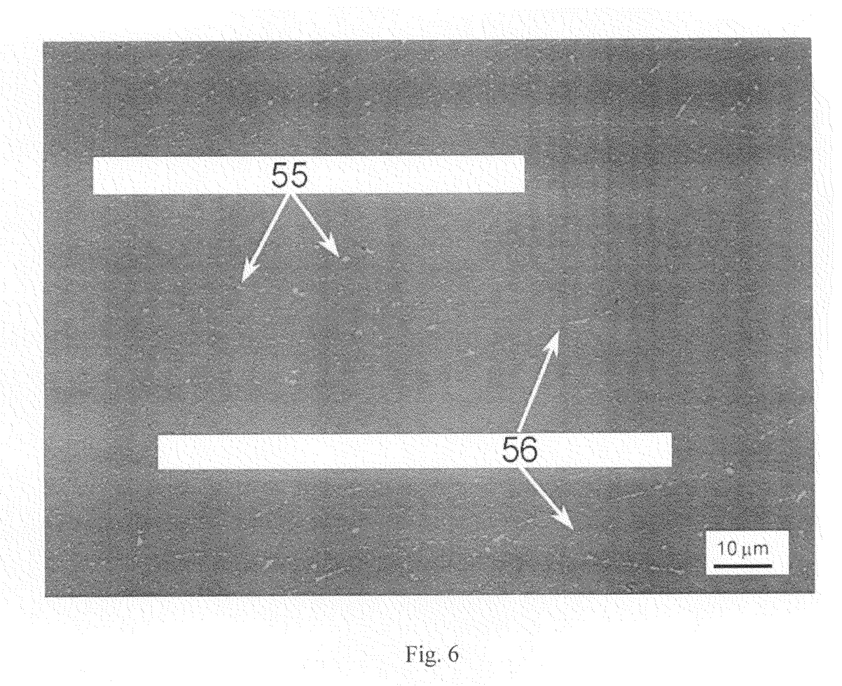

FIG. 5: Oxide layer 13 on an alloy 51 made of iron, chromium, manganese, lanthanum, niobium and tungsten with substitution by silicon.

FIG. 6: Precipitations (56) of the Fe₂(M, Si) type at alloy grain boundaries and precipitations (55) of the Fe₂(M, Si) type in the alloy grain.

The compositions listed below for an interconnector alloy (bipolar plate) have proven to be particularly advantageous with respect to the coefficient of expansion thereof, the creep resistance thereof, the oxidation resistance thereof, and the electrical conductivity of the oxidic cover layer. The percentages refer to wt % in each case.

1. Iron-based, 21 to 23% chromium, 0.2 to 0.6% manganese, 0.05 to 0.15% lanthanum, 0.4 to 1% niobium, 0.3 to 0.6% silicon, less than 0.1% aluminum, 0.001 to 0.02% carbon.

2. Iron-based, 21 to 23% chromium, 0.2 to 0.6% manganese, 0.05 to 0.15% lanthanum, 0.4 to 1% niobium, 0.3 to 0.6% silicon, 0.04 to 0.1% titanium, less than 0.1% aluminum, 0.001 to 0.04% carbon.

3. Iron-based, 21 to 23% chromium, 0.2 to 0.6% manganese, 0.05 to 0.15% lanthanum, 0.2 to 0.6% niobium, 1.5 to 3.5% tungsten, 0.3 to 0.6% silicon, less than 0.05% aluminum.

4. Iron-based, 21 to 23% chromium, 0.2 to 0.6% manganese, 0.05 to 0.15% lanthanum, 0.2 to 0.6% niobium, 1.5 to 3.5% tungsten, 0.3 to 0.6% silicon, 0.04 to 0.1% titanium, less than 0.08% aluminum, 0.001 to 0.01% carbon.

5. Iron-based, 21 to 23% chromium, 0.2 to 0.6% manganese, 0.05 to 0.15% lanthanum, 3.0 to 5.0% tungsten, 0.1 to 0.6% silicon, 0.02 to 0.1% titanium, less than 0.08% aluminum, 0.001 to 0.01% carbon.

6. Iron-based, 21 to 23% chromium, 0.2 to 0.6% manganese, 0.05 to 0.15% lanthanum, 5.0 to 7.0% tungsten, 0.2 to 0.8% silicon, 0.02 to 0.1% titanium, less than 0.08% aluminum, 0.001 to 0.01% carbon.

The microstructural conditions of the novel alloy and the influence on oxide growth rates shall be described again with reference to the alloy mentioned in number 4:

FIG. 1 shows an oxide layer 13 on an iron-based alloy 11 comprising 21 to 23% chromium, 0.2 to 0.6% manganese and 0.05 to 0.15% lanthanum, with alloy grain boundaries 12. The oxide layer 13 made of Cr₂O₃ and Cr₂MnO₄ forms at 800° C. in air.

FIG. 2 shows the oxide layer 13 on an alloy 21, to which 0.02 to 0.1% titanium was added as compared to the alloy 11 according to FIG. 1. As a result, fine inner oxidation particles of Ti oxide form beneath the Cr₂O₃ layer.

FIG. 3 shows the oxide layer 13 on an alloy 31, which additionally comprises 0.3 to 0.6% silicon, as compared to the alloy 21 according to FIG. 2. Due to the addition of silicon, precipitations of SiO₂ form at, and in the vicinity of, the interface between the alloy and oxide. These bring about the undesirable formation of metal inclusions 34 and an increase in the oxidation rate. The oxide layer is therefore considerably thicker than in FIGS. 1 and 2. The formation of metal inclusions and the increase in the oxidation rate also occur if 0.3 to 0.6% silicon is added to a titanium-free alloy (see also FIG. 1).

FIG. 4 shows the oxide layer 13 on an alloy 41, to which 0.2 to 0.6% niobium and 1.5 to 3.5% tungsten were added, as compared to the alloy 11 according to FIG. 1. A niobium-rich oxide layer 47 is located between the oxide layer 13 and the alloy 41. Due to the addition of niobium and tungsten, precipitations 45 of the Fe₂M type form in the alloy grain. Precipitations 46 of the Fe2M type form at the alloy grain boundaries, thereby providing the alloy with higher creep resistance. The disadvantage, however, is that the oxidation rate is drastically increased. After the same aging time, the oxide layer on the alloy 41 is considerably thicker than on the alloy 11. Additional doping with 0.02 to 0.1% titanium would bring about fine inner oxidation particles as is shown in FIGS. 2 and 3.

FIG. 5 shows the embodiment according to the invention comprising the oxide layer 13 on an alloy 51, to which 0.2 to 0.6% niobium, 1.5 to 3.5% tungsten and 0.3 to 0.6% silicon were added, as compared to the alloy 11 according to FIG. 1. As a result, precipitations 55 of the Fe₂(M, Si) type form in the alloy grain. Precipitations 56 of the Fe₂(M, Si) type form at the alloy grain boundaries. Due to the precipitations 55 and 56, the alloy is provided with higher creep resistance. In contrast to the alloy 41 according to FIG. 4, the oxidation rate is not increased by the addition of the Nb and W elements, as compared to the alloy 11 from FIG. 1. After the same aging time, the oxide layer on the alloy 51 according to FIG. 5 has a similar thickness as that on the alloy 11 according to FIG. 1. Additional doping with 0.02 to 0.1% titanium would bring about fine inner oxidation particles as is shown in FIGS. 2 and 3.

FIG. 6 shows a scanning electron microscopic image of the precipitations 55 and 56 according to FIG. 5.

1-20. (canceled)

21. A ferritic steel comprised of an iron-based alloy, the iron-based alloy comprising:
21 to 23 wt % chromium,
0.2 to 0.6 wt % manganese,
0.4 to 1.0 wt % niobium,
1.5 to 3.5 wt % tungsten,
0.3 to 0.6 wt % silicon, and
up to 0.15 wt % aluminum, and
at least one element having oxygen affinity selected from the group consisting of yttrium, lanthanum, zirconium, cerium or hafnium;
wherein, at temperatures of 700° to 900° C., the alloy forms precipitations comprised of an intermetallic phase of either or both of the Fe₂(M, Si)-type or the Fe₇(M, Si)₆-type, wherein M is at least one element selected from the group consisting of niobium, molybdenum, tungsten or tantalum.

22. The ferritic steel according to claim 21, wherein the volume percentage of the precipitations comprised of an intermetallic phase of either or both of the Fe₂(M, Si)-type and Fe₇(M, Si)₆-type intermetallic phases is between 1 and 8 vol %.

23. The ferritic steel of claim 22 wherein the volume percentage of the precipitations comprised of either or both of the Fe₂(M, Si)-type and Fe₇(M, Si)₆-type intermetallic phases is between 2.5 and 5 vol %.

24. The ferritic steel of claim 21 wherein the atomic percent Si in the intermetallic phase of the either or both Fe₂(M, Si)-type and Fe₇(M, Si)₆-type intermetallic phases is between 2 and 15 at %.

25. The ferritic steel of claim 21 wherein the iron-based alloy further comprises nickel and cobalt in a combined amount of up to 4 wt %.

26. The ferritic steel of claim 21 wherein the iron-based alloy further comprises carbon, nitrogen, sulfur, boron and phosphorus, each in an amount less than 0.1 wt %.

27. The ferritic steel of claim 26 wherein the amounts of carbon, nitrogen, sulfur, boron and phosphorus are each less than 0.02 wt %.

28. The ferritic steel of claim 21 wherein the total weight percent of elements having oxygen affinity in the iron-based alloy is between 0.01 and 1 wt %.

29. The ferritic steel of claim 28 wherein the total weight percent of elements having oxygen affinity in the iron-based alloy is between 0.05 and 0.3 wt %.

30. The ferritic steel of claim 21 wherein the at least one element having oxygen affinity is in the form of an oxide dispersion.

31. The ferritic steel of claim 30 wherein the concentration of the oxide dispersion in the iron-based alloy is between 0.1 and 2 wt %.

32. The ferritic steel of claim 31 wherein the concentration of the oxide dispersion in the iron-based alloy is between 0.4 and 1 wt %.

33. The ferritic steel of claim 21 wherein the iron-based alloy further comprises an element, E, wherein element E forms a spinel phase with Cr₂O₃ of the ECr₂O₄ type on the surface of the steel at temperatures above 500° C.; wherein element E is selected from the group consisting of manganese, nickel, cobalt, and copper.

34. The ferritic steel of claim 33 wherein the iron-based alloy comprises between 0.05 and 2 wt % of element E.

35. The ferritic steel of claim 34 wherein the iron-based alloy comprises between 0.2 and 1 wt % of element E.

36. The ferritic steel of claim 21 wherein the iron-based alloy further comprises added titanium in an amount of less than 0.2 wt %.

37. The ferritic steel of claim 36 wherein the amount of added titanium is less than 0.1 wt %.

38. Use of the ferritic steel of claim 21 in a fuel cell stack.

39. A bipolar plate for a fuel cell stack fabricated in whole or in part of a ferritic steel comprised of an iron-based alloy, the iron-based alloy comprising: 21 to 23 wt % chromium, 0.2 to 0.6 wt % manganese, 0.4 to 1.0 wt % niobium, 1.5 to 3.5 wt % tungsten, 0.3 to 0.6 wt % silicon, and up to 0.15 wt % aluminum, and at least one element having oxygen affinity and selected from the group consisting of yttrium, lanthanum, zirconium, cerium or hafnium; wherein, at temperatures of 700° to 900° C., the alloy forms precipitations comprised of an intermetallic phase of either or both of the Fe₂(M, Si)-type or the Fe₇(M, Si)₆-type, wherein M is at least one element selected from the group consisting of niobium, molybdenum, tungsten or tantalum and further wherein the volume percentage of the precipitations comprised of an intermetallic phase of either or both of the Fe₂(M, Si)-type and Fe₇(M, Si)₆-type intermetallic phases is between 1 and 8 vol %.

40. A ferritic steel comprised of an iron-based alloy, the iron-based alloy comprising:
21 to 23 wt % chromium,
0.2 to 0.6 wt % manganese,
0.4 to 1.0 wt % niobium,
1.5 to 3.5 wt % tungsten,
0.3 to 0.6 wt % silicon, and
up to 0.15 wt % aluminum, and
0.1 to 1.0% of at least one element having oxygen affinity selected from the group consisting of yttrium, lanthanum, zirconium, cerium or hafnium;
wherein the at least one element having oxygen affinity is in the form of an oxide dispersion;
wherein, at temperatures of 700° to 900° C., the alloy forms precipitations comprised of an intermetallic phase of either or both of the Fe₂(M, Si)-type or the Fe₇(M, Si)₆-type, wherein M is at least one element selected from the group consisting of niobium, molybdenum, tungsten or tantalum.
